(19) United States
(12) Patent Application Publication
(10) Pub. No.: US 2025/0326153 A1
(43) Pub. Date: Oct. 23, 2025

(54) CORN STRAW ECOLOGICAL BOARD AND PREPARATION METHOD THEREOF

(71) Applicant: Shanxi University, Taiyuan City (CN)

(72) Inventor: Xiuqing YANG, Taiyuan City (CN)

(21) Appl. No.: 19/030,058

(22) Filed: Jan. 17, 2025

(30) Foreign Application Priority Data
Apr. 22, 2024 (CN) 202410481008.8

(51) Int. Cl. B27N 1/02; B27N 3/00; B27N 3/02; B27N 3/10; B27N 3/18

(52) U.S. Cl. CPC B27N 1/0209; B27N 3/002; B27N 3/02; B27N 3/10; B27N 3/18

(57) ABSTRACT

A corn straw ecological board and a preparation method thereof are provided. The preparation method includes: (1) mixing a corn straw powder and a sizing material to obtain a mixed material, and then dividing the mixed material into a surface wet material and a core wet material; (2) drying the surface wet material and the core wet material obtained in step (1) respectively to obtain a surface material and a core material, wherein the surface material has a moisture content of 25% to 30%, and the core material has a moisture content of 10% to 15%; and (3) laying the core material and the surface material obtained in step (2) in a surface-core-surface manner, and then subjecting a resulting system to pre-pressing and hot-pressing in sequence to obtain the corn straw ecological board.

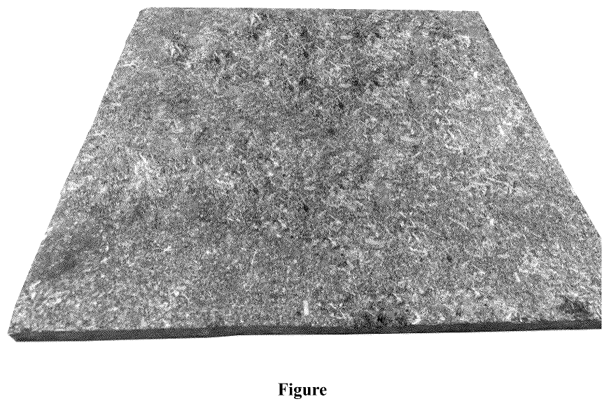

### CROSS REFERENCE TO RELATED APPLICATION

This patent application claims the benefit and priority of Chinese Patent Application No. 2024104810088 filed with the China National Intellectual Property Administration on Apr. 22, 2024, the disclosure of which is incorporated by reference herein in its entirety as part of the present application.

### TECHNICAL FIELD

The present disclosure relates to the technical field of board processing, and in particular to a corn straw ecological board and a preparation method thereof.

### BACKGROUND

China is the largest producer of crop straws in the world due to wide variety and large total amount, accounting for nearly one-fifth of the global straw resources. In traditional corn cultivation, only a small portion of corn straws is utilized. Most of the corn straws are burned in the open air, and the rest are piled on a roadside, not only causing air pollution but also affecting traffic safety.

The utilization of straws as raw materials has found a way to “value-added” for idle straw resources. After active exploration and practice, the technology of the utilization of the straws as the raw materials has made positive progress. Using the corn straw as a main raw material for board materials to prepare artificial boards could not only make reasonable use of the corn straw, but also effectively alleviate the pressure on scarce forest resources, thereby greatly reducing the felling of wood. However, loose fibers of the corn straw cause the boards made therefrom to have a large porosity, resulting in strong water absorption, low strength, and easy deformation.

### SUMMARY

The present disclosure is intended to provide a corn straw ecological board and a preparation method thereof. In the present disclosure, the corn straw ecological board has a low water absorption thickness swelling (TS) and a high strength.

To achieve the above objects, the present disclosure provides the following technical solutions.

The present disclosure provides a method for preparing a corn straw ecological board, including the following steps:
(1) mixing a corn straw powder and a sizing material to obtain a mixed material, and then dividing the mixed material into a surface wet material and a core wet material, where a mass ratio of the surface wet material to the core wet material is in a range of 1:1 to 1:2, and the sizing material includes an enzyme-modified soybean adhesive, a hydrophobic agent, and a binder;
(2) drying the surface wet material and the core wet material obtained in step (1) respectively to obtain a surface material and a core material, where the surface material has a moisture content of 25% to 30%; and the core material has a moisture content of 10% to 15%; and
(3) laying the core material and the surface material obtained in step (2) in a surface-core-surface manner, and then subjecting a resulting system to pre-pressing and hot-pressing in sequence to obtain the corn straw ecological board.

In some embodiments, the corn straw powder in step (1) has a particle size of 40 mesh to 60 mesh.

In some embodiments, a mass of the sizing material in step (1) is 10% to 14% of a mass of the corn straw powder.

In some embodiments, the enzyme-modified soybean adhesive in step (1) includes the following components by mass percentage: 10% to 14% of a soybean protein, 0.02% to 0.15% of a protease, 0.01% to 0.015% of an alkali, 0.001% to 0.0015% of a preservative, and deionized water as a balance.

In some embodiments, the protease includes one selected from the group consisting of laccase, caseinase, and transglutaminase.

In some embodiments, a mass of the hydrophobic agent in step (1) is 1% to 1.4% of a mass of the enzyme-modified soybean adhesive.

In some embodiments, a mass of the binder in step (1) is 40% to 60% of a mass of the enzyme-modified soybean adhesive.

In some embodiments, the pre-pressing in step (3) is conducted at a pressure of 0.4 MPa to 0.5 MPa for 20 seconds to 40 seconds.

In some embodiments, the hot-pressing in step (3) is conducted at a temperature of 120° C. to 140° C. under a pressure of 1.5 MPa to 2.5 MPa for 15 minutes to 20 minutes.

The present disclosure further provides a corn straw ecological board prepared by the method described in the above technical solutions.

The present disclosure provides a method for preparing a corn straw ecological board, including the following steps: (1) mixing a corn straw powder and a sizing material to obtain a mixed material, and then drying the mixed material respectively in a mass ratio of 1:1 to 1:2 to obtain a surface material and a core material; where the sizing material includes an enzyme-modified soybean adhesive, a hydrophobic agent, and a binder; the surface material has a moisture content of 25% to 30%; and the core material has a moisture content of 10% to 15%; and (2) laying the core material and the surface material obtained in step (1) in a surface-core-surface manner, and then subjecting a resulting system to pre-pressing and hot-pressing in sequence to obtain the corn straw ecological board. In the present disclosure, the corn straw powder and sizing material are mixed, and a density of the prepared board could be increased by controlling a mass ratio of the core wet material to the surface wet material, thereby enhancing a strength of the prepared ecological board. Then, the surface material with a moisture content of 25% to 30% and the core material with a moisture content of 10% to 15% are obtained by drying the core wet material and the surface wet material, respectively. The moisture content of the core material is lower than that of the surface material, forming a gradient, which is conducive to transfer of the hot-pressing temperature, thereby facilitating subsequent compression of the core layer and the surface layer, increasing the density, and then enhancing the strength of the prepared ecological board. By using the enzyme-modified soybean adhesive, the hydrophobic agent, and the binder as the sizing material, the prepared ecological board is free of formaldehyde release, and the hydrophobic agent could reduce a water absorption of the prepared ecological board. The surface material and core material with the same main components but different moisture content are laid in a surface-core-surface manner, which could ensure a structural stability of the prepared ecological board, and the surface material and the core material could restrain each other, release stress, avoid expansion and cracking, and then make the prepared ecological board stable and strong. By pre-pressing and hot-pressing, the corn straw powder and the sizing material are compacted, which could further increase the density of the ecological board and thus increase the strength of the ecological board. Results of examples show that an ecological board prepared by the method in the present disclosure has a density of up to 0.96 g/cm³, a modulus of rupture (MOR) of up to 18.2 MPa, a modulus of elasticity (MOE) of up to 2,865 MPa, and a water absorption thickness swelling (TS) as low as 12.3%.

### BRIEF DESCRIPTION OF THE DRAWINGS

Figure shows a physical picture of the corn straw ecological board prepared in Example 1.

### DETAILED DESCRIPTION OF THE EMBODIMENTS

The present disclosure provides a method for preparing a corn straw ecological board, including the following steps:
(1) mixing a corn straw powder and a sizing material to obtain a mixed material, and then dividing the mixed material into a surface wet material and a core wet material, where a mass ratio of the surface wet material to the core wet material is in a range of 1:1 to 1:2, and the sizing material includes an enzyme-modified soybean adhesive, a hydrophobic agent, and a binder;
(2) drying the surface wet material and the core wet material obtained in step (1) respectively to obtain a surface material and a core material, where the surface material has a moisture content of 25% to 30%, and the core material has a moisture content of 10% to 15%; and
(3) laying the core material and the surface material obtained in step (2) in a surface-core-surface manner, and then subjecting a resulting system to pre-pressing and hot-pressing in sequence to obtain the corn straw ecological board.

In the present disclosure, a corn straw powder and a sizing material are mixed to obtain a mixed material, and then the mixed material is divided into a surface wet material and a core wet material.

In some embodiments of the present disclosure, the corn straw powder has a particle size of 40 mesh to 60 mesh. In some embodiments of the present disclosure, the corn straw powder has a moisture content of 5% to 10%.

In some embodiments of the present disclosure, a process for preparing the corn straw powder includes: drying and crushing corn straws in sequence to obtain the corn straw powder. In some embodiments of the present disclosure, the drying is conducted at a temperature of 80° C. to 95° C. There is no particular limitation on a drying equipment, and any drying equipment known in the art may be adopted. There is no particular limitation on a crushing equipment, and any crushing equipment known in the art may be adopted. In some embodiments of the present disclosure, the crushing equipment is a crusher.

In the present disclosure, the sizing material includes an enzyme-modified soybean adhesive, a hydrophobic agent, and a binder. The enzyme-modified soybean adhesive, the hydrophobic agent, and the binder as the sizing material, a prepared ecological board is free of formaldehyde release, and the hydrophobic agent could reduce a water absorption of the ecological board.

In some embodiments of the present disclosure, the enzyme-modified soybean adhesive includes the following components by mass percentage: 10% to 14% of a soybean protein, 0.02% to 0.15% of a protease, 0.01% to 0.015% of an alkali, 0.001% to 0.0015% of a preservative, and deionized water as a balance.

In some embodiments of the present disclosure, the enzyme-modified soybean adhesive includes 10% to 14%, and preferably 12% by mass percentage of the soybean protein. The soybean protein makes the prepared enzyme-modified soybean adhesive sticky and formaldehyde-free, and the prepared enzyme-modified soybean adhesive has better stickiness by limiting a content of the soybean protein.

In some embodiments of the present disclosure, the enzyme-modified soybean adhesive includes 0.02% to 0.15%, and preferably 0.05% to 0.1% by mass percentage of the protease. In some embodiments of the present disclosure, the protease is one selected from the group consisting of laccase, caseinase, and transglutaminase. A certain amount of the protease modifies the soybean protein, which could induce protein molecules to form covalent cross-links, thereby enhancing a bonding strength of the enzyme-modified soybean adhesive, and further enhancing a strength of a prepared environmentally-friendly single-layer particleboard.

In some embodiments of the present disclosure, the enzyme-modified soybean adhesive includes 0.01% to 0.015%, and preferably 0.013% by mass percentage of the alkali. In some embodiments of the present disclosure, the alkali is a NaOH solution with a concentration of 4 mol/L to 6 mol/L. A pH value of the soybean protein is adjusted by limiting a content of the alkali, thereby enhancing a reactivity of the soybean protein, which is beneficial to the subsequent modification of the soybean protein by the protease.

In some embodiments of the present disclosure, the enzyme-modified soybean adhesive includes 0.001% to 0.0015%, and preferably 0.0013% by mass percentage of the preservative. In some embodiments of the present disclosure, the preservative is an industrial-grade broad-spectrum microbicide, and active ingredients thereof are benzisothiazolinone and methylisothiazolinone.

In some embodiments of the present disclosure, a process for preparing the enzyme-modified soybean adhesive includes: mixing the soybean protein, the deionized water, and the preservative, and then sequentially adding the alkali and the protease to allow mixing, and then subjecting a resulting mixture to cross-linking to obtain the enzyme-modified soybean adhesive.

In some embodiments of the present disclosure, the soybean protein, the deionized water, and the preservative are mixed in a glass reactor. In some embodiments of the present disclosure, the mixing of the soybean protein, the deionized water, and the preservative and the subsequent mixing of the alkali and the protease are conducted under stirring. In some embodiments of the present disclosure, the stirring is conducted at a stirring rate of 30 r/min to 60 r/min.

In some embodiments of the present disclosure, the cross-linking is conducted at a pH value of 8 to 8.5. In some embodiments of the present disclosure, the cross-linking includes room-temperature cross-linking and high-temperature cross-linking conducted sequentially. In some embodiments of the present disclosure, the room-temperature cross-linking is conducted for 12 h to 24 h. In some embodiments of the present disclosure, the high-temperature cross-linking is conducted for 10 h to 12 h. In some embodiments of the present disclosure, the high-temperature cross-linking is conducted at a temperature of 30° C. to 35° C. The high-temperature cross-linking is conducted in a water bath.

In some embodiments of the present disclosure, the hydrophobic agent includes a paraffin emulsion with a mass concentration of 30% to 35%. In some embodiments of the present disclosure, a mass of the hydrophobic agent is 1% to 1.4%, and preferably 1.2% of a mass of the enzyme-modified soybean adhesive. The water absorption of the prepared ecological board could be further reduced by limiting a content of the hydrophobic agent.

In some embodiments of the present disclosure, the binder includes a calcium chloride solution with a mass concentration of 5% to 10%. In some embodiments of the present disclosure, a mass of the binder is 40% to 60%, and preferably 45% to 55% of the mass of the enzyme-modified soybean adhesive. Limiting a content of the binder could further improve fluidity of the sizing material, make the sizing material and corn straw powder mix more fully, and further increase viscosity and strength of the enzyme-modified soybean adhesive.

In the present disclosure, there is no particular limitation on a process for preparing the sizing material, and any process of the sizing material well known in the art may be adopted. In some embodiments of the present disclosure, the process for preparing the sizing material is to mix the enzyme-modified soybean adhesive, the hydrophobic agent, and the binder to obtain the sizing material.

In some embodiments of the present disclosure, a mass of the sizing material is 10% to 14%, and preferably 12% to 13% of the mass of the corn straw powder. Limiting the mass of the sizing material could make the corn straw powder more fully bonded, thereby enhancing strength of the prepared corn straw ecological board.

In some embodiments of the present disclosure, the corn straw powder and the sizing material are mixed under stirring. In some embodiments of the present disclosure, the stirring is conducted at a stirring rate of 60 r/min to 80 r/min, and preferably 70 r/min. In some embodiments of the present disclosure, the corn straw powder and the sizing material are mixed in a drum mixer. In some embodiments of the present disclosure, the corn straw powder is added into the drum mixer, and then the sizing material is sprayed onto the corn straw powder using a high-pressure spray gun to obtain a mixed material.

In the present disclosure, a mass ratio of the surface wet material to the core wet material is in a range of 1:1 to 1:2. Controlling the mass ratio of the surface wet material to the core wet material could increase density of the prepared board, thereby enhancing the strength of the prepared ecological board.

In the present disclosure, the surface wet material and the core wet material are dried respectively to obtain a surface material and a core material.

In some embodiments of the present disclosure, the surface wet material is dried at a temperature of 70° C. to 75° C. for 20 minutes to 30 minutes. In some embodiments of the present disclosure, the core wet material is dried at a temperature of 80° C. to 85° C. for 90 min to 120 min. In some embodiments of the present disclosure, the surface material has a moisture content of 25% to 30%, and preferably 27%; the core material has a moisture content of 10% to 15%, and preferably 13%. The moisture content of the surface material and the core material is limited such that the moisture content of the core material is lower than the moisture content of the surface material, forming a gradient, which is conducive to transfer of a hot-pressing temperature, thereby facilitating subsequent compression of the core material and the surface material, increasing the density, and further enhancing the strength of the prepared ecological board. There is no particular limitation on a drying equipment, and any drying equipment known in the art may be adopted. In some embodiments of the present disclosure, the drying equipment is a rotary drying box.

In the present disclosure, the core material and the surface material are laid in a surface-core-surface manner, and then a resulting system is subjected to pre-pressing and hot-pressing in sequence to obtain the corn straw ecological board.

In the present disclosure, the laying is conducted in the surface-core-surface manner. The laying is limited to ensure structural stability of the ecological board, and the surface material and the core material could restrain each other, release stress, and avoid expansion and cracking, such that the ecological board has desirable stability and high strength.

In some embodiments of the present disclosure, the pre-pressing is conducted under a pressure of 0.4 MPa to 0.5 MPa. In some embodiments of the present disclosure, the pre-pressing is conducted for 20 seconds to 40 seconds, and preferably 25 seconds to 35 seconds. In some embodiments of the present disclosure, the hot-pressing is conducted at a temperature of 120° C. to 140° C., and preferably 125° C. to 135° C. In some embodiments of the present disclosure, the hot-pressing is conducted under a pressure of 1.5 MPa to 2.5 MPa, and preferably 2 MPa. In some embodiments of the present disclosure, the hot-pressing is conducted for 15 minutes to 20 minutes, and preferably 17 minutes. By limiting the pre-pressing and the hot-pressing, the corn straw powder and the sizing material are compacted, which could further increase the density of the ecological board and thus increase the strength of the ecological board.

In some embodiments of the present disclosure, a board obtained by the hot-pressing is subjected to pasting a decorative surface layer and standing in sequence to obtain the corn straw ecological board.

In some embodiments of the present disclosure, a method for the pasting the decorative surface layer includes the following steps: applying an adhesive to a surface of the board obtained by the hot-pressing, and then conducting secondary hot-pressing to obtain the board with the decorative surface layer pasted. In some embodiments of the present disclosure, the adhesive is the enzyme-modified soybean adhesive. In some embodiments of the present disclosure, the enzyme-modified soybean adhesive is added at 0.05% to 0.15% of a mass of the board after the decorative surface layer is pasted. In some embodiments of the present disclosure, the adhesive is applied at a sizing amount of 250-300 g/m², and preferably 260-280 g/m². In some embodiments of the present disclosure, after the adhesive is applied, the board is aged at room temperature for 15 minutes to 20 minutes. In some embodiments of the present disclosure, the secondary hot-pressing is conducted at a temperature of 130° C. to 140° C. under a pressure of 0.8 MPa to 1 MPa for 4 minutes to 8 minutes. The secondary hot-pressing is limited to making the adhesive bond to the surface of the board more fully.

In some embodiments of the present disclosure, the standing is conducted for 5 days to 7 days. Limiting the standing time further reduces a moisture content of the prepared corn straw ecological board.

In the present disclosure, the corn straw powder and sizing material are mixed, and a density of the prepared board could be increased by controlling a mass ratio of the core wet material to the surface wet material, thereby enhancing the strength of the prepared ecological board. Then, the surface material with a moisture content of 25% to 30% and the core material with a moisture content of 10% to 15% are obtained by drying the core wet material and the surface wet material, respectively. The moisture content of the core material is lower than the moisture content of the surface material, forming a gradient, which is conducive to the transfer of hot-pressing temperature, thereby facilitating the subsequent compression of the core layer and the surface layer, increasing the density, and then enhancing the strength of the prepared ecological board. By using the enzyme-modified soybean adhesive, the hydrophobic agent, and the binder as the sizing material, the prepared ecological board is free of formaldehyde release, and the hydrophobic agent could reduce the water absorption of the prepared ecological board. The surface material and core material with the same main components but different moisture content are laid in the surface-core-surface manner, which could ensure a structural stability of the prepared ecological board, and the surface material and the core material could restrain each other, release stress, avoid expansion and cracking, and then make the prepared ecological board stable and strong. By pre-pressing and hot-pressing, the corn straw powder and the sizing material are compacted, which could further increase the density of the ecological board and thus increase the strength of the ecological board. Results of examples show that an ecological board prepared by the method in the present disclosure has a density of up to 0.96 g/cm³, a modulus of rupture (MOR) of up to 18.2 MPa, a modulus of elasticity (MOE) of up to 2,865 MPa, and a water absorption thickness swelling (TS) as low as 12.3%.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the scope of the present disclosure.

### Example 1

A method for preparing a corn straw ecological board was performed by the following steps.

(1) A corn straw powder was placed in a drum mixer with a stirring rate of 60 r/min, and a sizing material was sprayed into the corn straw powder with a high-pressure spray gun to form a mixed wet material. The mixed wet material was divided into a surface wet material and a core wet material in a mass ratio of 1:1 and 1:2; where a mass of the sizing material was 13% of a mass of the corn straw powder. The sizing material consisted of an enzyme-modified soybean adhesive, a hydrophobic agent (a paraffin emulsion), and a binder (a calcium chloride solution). A mass of the hydrophobic agent was 1% of a mass of the enzyme-modified soybean adhesive; a mass of the binder was 60% of the mass of the enzyme-modified soybean adhesive; the enzyme-modified soybean adhesive consisted of: 10% of a soybean protein, 0.02% of a protease, 0.01% of an alkali (sodium hydroxide), 0.001% of a preservative (benzisothiazolinone and methylisothiazolinone), and deionized water as a balance. The enzyme-modified soybean adhesive was prepared by the following steps: the soybean protein, the deionized water, and the preservative were mixed at 50 r/min, the alkali was added to adjust a pH value to 8.2 under stirring, and then the protease was added and mixed, reacted at room temperature for 2 h and then reacted in a 37° C. water bath for 12 h to obtain the enzyme-modified soybean adhesive. The corn straw powder was prepared by the following steps: a corn straw was dried at 90° C., and then crushed in a crusher to obtain the corn straw powder with a moisture content of 6% and a particle size of 40-60 mesh.

(2) The surface wet material obtained in step (1) was dried in a rotary drying oven at 70° C. for 20 minutes to obtain a surface material with a moisture content of 30%. The core wet material obtained in step (1) was dried in a rotary drying oven at 80° C. for 120 minutes to obtain a core material with a moisture content of 10%.

(3) The core material and the surface material obtained in step (2) were laid in a surface-core-surface manner, and a resulting system was subjected to pre-pressing under 0.4 MPa for 40 seconds and then hot-pressing at 140° C. under 1.5 MPa for 15 minutes. A board after the hot-pressing was pasted with a decorative surface layer: the enzyme-modified soybean adhesive with an addition amount of 6% of a mass of the board after the decorative surface layer was pasted and a sizing amount of 250 g/m² was applied to coat a surface of the board, aged at room temperature for 20 minutes, and subjected to hot-pressing at 140° C. under 0.8 MPa for 6 minutes. After the board was pasted with the decorative surface layer, it was allowed to stand for 7 days to obtain the corn straw ecological board, as shown in Figure.

### Example 2

This example was performed according to Example 1 except that: in step (3), pre-pressing and hot-pressing were conducted in sequence after laying was completed, where the hot-pressing was conducted under 2 MPa.

### Example 3

This example was performed according to Example 1 except that: in step (3), pre-pressing and hot-pressing were conducted in sequence after laying was completed, where the hot-pressing was conducted under 2.5 MPa.

### Comparative Example 1

This example was performed according to Example 1 except that: in step (1), an enzyme-modified soybean adhesive was replaced by an urea-formaldehyde resin.

In the present disclosure, performances of the corn straw ecological board prepared in Examples 1 to 3 and Comparative Examples 1 to 2 were tested according to the procedure specified in the Chinese national standard GBT 4897-2015:

Two samples with a size of 300 mm×50 mm were taken from each board for measuring a modulus of rupture (MOR) and a modulus of elasticity (MOE). The MOR and MOE were measured using a universal testing machine by a three-point bending test, and an operating speed of the universal testing machine was controlled at 10 mm/min. Average values were taken as the MOR and the MOE of the board.

Two samples with a size of 50 mm×50 mm were taken from each board to measure their water absorption thickness swelling (TS). The samples were immersed in water (25±0.1° C.) for 2 h. A thickness of a center point of the sample before and after immersion was measured with a micrometer, and the TS of the sample at 2 h was calculated. Average values were taken as the TS at 2 h of the board.

Ten samples with a size of 50 mm×50 mm were taken from each board for measuring its density. Average values were taken as the density of the board.

In order to characterize and analyze the board, samples with a suitable density and a size of 50 mm×50 mm were selected for cross-sectional density measurement. Test results are shown in Table 1.

TABLE 1
Performance results of corn straw ecological boards prepared
in Examples 1 to 3 and Comparative Examples 1 to 2

| | Density | MOR | MOE | Water absorption |
|---|---|---|---|---|
| Group | (g/cm³) | (MPa) | (MPa) | TS (%) |
| Example 1 | 0.76 | 12.5 | 1926 | 47.2 |
| Example 2 | 0.85 | 15.1 | 2276 | 35.6 |
| Example 3 | 0.96 | 18.2 | 2865 | 12.3 |
| Comparative | 0.76 | 14.1 | 2053 | 50.2 |
| Example 1 | | | | |

As shown in Table 1, compared with the corn straw board made of the urea-formaldehyde resin in Comparative Example 1, the corn straw ecological board made of the enzyme-modified soybean adhesive in Example 1 is free of formaldehyde release and the water absorption TS is lower than that of Comparative Example 1. This indicated that the corn straw ecological board has low water absorption TS and high strength, and is free of formaldehyde release.

The above descriptions are merely preferred embodiments of the present disclosure. It should be noted that a person of ordinary skill in the art may further make several improvements and modifications without departing from the principle of the present disclosure, but such improvements and modifications should also be deemed as falling within the scope of the present disclosure.

What is claimed is:

1. A method for preparing a corn straw ecological board, comprising the following steps:
(1) mixing a corn straw powder and a sizing material to obtain a mixed material, and then dividing the mixed material into a surface wet material and a core wet material, wherein a mass ratio of the surface wet material to the core wet material is in a range of 1:1 to 1:2, and the sizing material comprises an enzyme-modified soybean adhesive, a hydrophobic agent, and a binder;
(2) drying the surface wet material and the core wet material obtained in step (1) respectively to obtain a surface material and a core material, wherein the surface material has a moisture content of 25% to 30%, and the core material has a moisture content of 10% to 15%; and
(3) laying the core material and the surface material obtained in step (2) in a surface-core-surface manner, and then subjecting a resulting system to pre-pressing and hot-pressing in sequence to obtain the corn straw ecological board.

2. The method of claim 1, wherein the corn straw powder in step (1) has a particle size of 40 mesh to 60 mesh.

3. The method of claim 1, wherein a mass of the sizing material in step (1) is 10% to 14% of a mass of the corn straw powder.

4. The method of claim 1, wherein the enzyme-modified soybean adhesive in step (1) comprises the following components by mass percentage: 10% to 14% of a soybean protein, 0.02% to 0.15% of a protease, 0.01% to 0.015% of an alkali, 0.001% to 0.0015% of a preservative, and deionized water as a balance.

5. The method of claim 4, wherein the protease comprises one selected from the group consisting of laccase, caseinase, and transglutaminase.

6. The method of claim 1, wherein a mass of the hydrophobic agent in step (1) is 1% to 1.4% of a mass of the enzyme-modified soybean adhesive.

7. The method of claim 1, wherein a mass of the binder in step (1) is 40% to 60% of a mass of the enzyme-modified soybean adhesive.

8. The method of claim 1, wherein the pre-pressing in step (3) is conducted at a pressure of 0.4 MPa to 0.5 MPa for 20 seconds to 40 seconds.

9. The method of claim 1, wherein the hot-pressing in step (3) is conducted at a temperature of 120° C. to 140° C. under a pressure of 1.5 MPa to 2.5 MPa for 15 minutes to 20 minutes.

10. A corn straw ecological board prepared by the method of claim 1.

11. The corn straw ecological board of claim 10, wherein the corn straw powder in step (1) has a particle size of 40 mesh to 60 mesh.

12. The corn straw ecological board of claim 10, wherein a mass of the sizing material in step (1) is 10% to 14% of a mass of the corn straw powder.

13. The corn straw ecological board of claim 10, wherein the enzyme-modified soybean adhesive in step (1) comprises the following components by mass percentage: 10% to 14% of a soybean protein, 0.02% to 0.15% of a protease, 0.01% to 0.015% of an alkali, 0.001% to 0.0015% of a preservative, and deionized water as a balance.

14. The corn straw ecological board of claim 13, wherein the protease comprises one selected from the group consisting of laccase, caseinase, and transglutaminase.

15. The corn straw ecological board of claim 10, wherein a mass of the hydrophobic agent in step (1) is 1% to 1.4% of a mass of the enzyme-modified soybean adhesive.

16. The corn straw ecological board of claim 10, wherein a mass of the binder in step (1) is 40% to 60% of a mass of the enzyme-modified soybean adhesive.

17. The corn straw ecological board of claim 10, wherein the pre-pressing in step (3) is conducted at a pressure of 0.4 MPa to 0.5 MPa for 20 seconds to 40 seconds.

18. The corn straw ecological board of claim 10, wherein the hot-pressing in step (3) is conducted at a temperature of 120° C. to 140° C. under a pressure of 1.5 MPa to 2.5 MPa for 15 minutes to 20 minutes.
